(19) United States
(12) Patent Application Publication
(10) Pub. No.: US 2012/0105572 A1
(43) Pub. Date: May 3, 2012

(54) AUTOMATICALLY ADJUSTING A VIDEO-CAPTURE DEVICE

(76) Inventor: Russell P. SAMMON, San Francisco, CA (US)

(21) Appl. No.: 12/914,863

(22) Filed: Oct. 28, 2010

(51) Int. Cl. H04N 7/15; H04N 5/228

(52) U.S. Cl. 348/14.08; 348/222.1; 348/208.4; 348/E07.083; 348/E05.031

(57) ABSTRACT

A video-capture device is configured to determine when it is disposed on a supporting surface and, in response, automatically adjust one or more device settings to optimize the device settings for automatic mode. In various embodiments, a sensor, such as a grip sensor, an inertial sensor, or a pressure sensor included in the video-capture device, or an optical flow algorithm that quantifies visible shake may be used to detect when the video-capture device is disposed on the supporting surface. Automatically adjusting the settings of the video-capture device when the device is resting on a supporting surface provides a simpler and more seamless user experience and also improves the overall quality of video content being captured when the device is in automatic mode.

### BACKGROUND OF THE INVENTION

1. Field of the Invention

Embodiments of the present invention relate generally to video capture devices, and more specifically, to an automatically adjusting a video-capture device.

2. Description of the Related Art

Camcorders, video-capable cell phones, web cams, and other digital video capture devices are commonly used to record and/or transmit video content. Such digital video capture devices are typically hand-held devices aimed and operated by the user. In some instances, however, these digital video capture devices may be placed on a table, tripod, or other stable mount in order to capture a particular video, for example, when the user is included in the captured video.

In order to improve performance when a video capture device is placed on a stationary surface and is no longer operated by the user, a number of device settings typically need to be changed. For example, it may be desirable for the video capture device to automatically adjust the focus, field-of-view, etc. All such settings normally have to be manually set by the user, and failure to make such adjustments can adversely impact the quality of video captured in automatic mode. However, adjusting all the desired settings of the video capture device whenever the device is switched from being hand-held to resting on a stationary surface (and maybe back again) can be inconvenient and time-consuming for the user.

Even when such settings are adjusted accordingly, video quality generally suffers when a video capture device is not operated directly by the user, i.e., the video capture device is not hand-held. First, the user must position the device so that the desired subjects are disposed in frame exactly as desired, which is particularly problematic when the user is one of the desired subjects. Second, any movement on the part of the subjects will further reduce how well the video is framed.

As the foregoing illustrates, there is a need in the art for an improved way for a portable digital video capture device to transition between a manual operating mode, in which a user operates the video capture device directly, and an automatic operating mode, in which the video capture device captures video when not hand-held by the user.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of an exemplary video-capture device configured to implement one or more aspects of the invention.

FIG. 2 is a flow chart of a method for capturing video while using remote edge-of-frame warning indicators, according to one example embodiment of the invention.

FIG. 3A is a schematic diagram of a user interface screen of a video-capture device when the video-capture device is in manual capture mode, according to one example embodiment of the invention.

FIG. 3B is a schematic diagram of a user interface screen of a video-capture device when the video-capture device is in automatic capture mode, according to one example embodiment of the invention.

FIG. 4 is a flow chart of a method for displaying user prompts in manual mode and in automatic capture mode, according to one example embodiment of the invention.

FIG. 5 is a flow chart of a method for automatically activating video conferencing features of a video-capture device, according to one example embodiment of the invention.

FIG. 6 is a flow chart of a method for changing a video-capture device from a manual capture mode to an automatic capture mode, according to one example embodiment of the invention.

FIG. 7 is a flow chart of a method for capturing video, according to one example embodiment of the invention.

For clarity, identical reference numbers have been used, where applicable, to designate identical elements that are common between figures. It is contemplated that features of one embodiment may be incorporated in other embodiments without further recitation.

### DESCRIPTION OF EXAMPLE EMBODIMENTS

In the following description, numerous specific details are set forth to provide a more thorough understanding of various embodiments of the invention. However, it will be apparent to one of skill in the art that certain embodiments of the invention may be practiced without one or more of these specific details. In other instances, well-known features have not been described in order to avoid obscuring the invention.

### Overview

One example embodiment of the invention sets forth a method for capturing video in a video-capture device. The method includes determining that the video-capture device is disposed on a supporting surface, and, in response, automatically adjusting at least one setting of the video-capture device from a first setting to a second setting.

### Descriptions of Figures

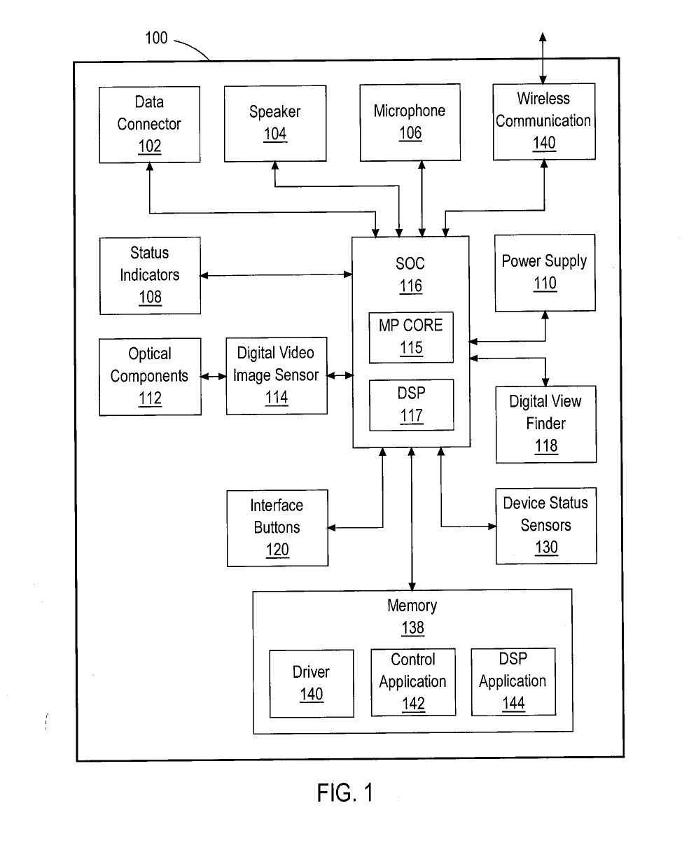

FIG. 1 is a block diagram of an exemplary video-capture device 100 configured to implement one or more aspects of the invention. Video-capture device 100 may be any hand-held device capable of capturing, i.e., recording, monitoring, and/or transmitting, video data, such as a pocket camcorder, smart-phone, etc. Video-capture device 100 includes a data connector 102, a speaker 104, a microphone 106, status indicators 108, a power supply 110, optical components 112, a digital video image sensor 114, a system on a chip (SOC) 116, a digital viewfinder 118, interface buttons 120, internal memory 138, device status sensors 130, and a wireless communication system 140.

Data connector 102 is an integrated mechanism that allows video-capture device 100 to be connected to a separate TV or computer system, such as a laptop or a desktop computer, and to transfer data to and from the TV and/or computer system. Data connector 102 may be a universal serial bus (USB), firewire, serial, or other suitable connector that is capable of connecting video-capture device 100 with a TV or computer system.

Microphone 106 captures the sound in the scene and converts the captured sound to digital audio data. Microphone 106 then transmits the digital audio data to SOC 116 for further processing. In some embodiments, microphone 106 may include one or more directional microphones, which may be used to support multi-channel audio, e.g., Dolby 5.1.

Status indicators 108 visually indicate the current mode of operation of video-capture device 100. Status indicators 108 include light emitting diodes (LEDs) that can be “ON,” blinking, or “OFF,” depending on the current operating mode of video-capture device 100. The operating modes of video-capture device 100 include, among others, a hand-held capture mode, an automatic capture mode, and a playback mode.

When in hand-held capture mode, video-capture device 100 is configured to capture video and audio of a particular scene through optical components 112 and microphone 106, respectively. The term “capturing,” as used herein, includes recording video, i.e., saving into persistent memory, transmitting video, and/or monitoring video, i.e., displaying video to digital viewfinder 118 while neither recording nor transmitting. Framing of subjects, pan, tilt and zoom of optical components 112, and other features of video-capture device 100 are left to the control of the user. When in automatic capture mode, video-capture device 100 is configured to capture video and audio of a particular scene automatically through optical components 112 and microphone 106, and one or more automatic features are enabled to enhance the quality of the captured video, such as auto-framing, subject tracking, digital tilt adjustment, etc. Features that may be activated in automatic capture mode are described in greater detail below. Automatic capture mode is used when video-capture device 100 is not hand-held and the user is unable to manually control video-capture device 100, such as when the user is taking part in the captured video, the user is conducting a video chatting session, or video-capture device 100 is positioned in such a way that limits being operated by the user, e.g., against a wall. When in playback mode, video-capture device 100 is configured to play previously captured digital videos that are stored in internal memory 138. In one embodiment, such digital videos may be displayed on digital viewfinder 118 and the audio may be output through speaker 104. In alternative embodiments, the digital video and audio may be output to a TV or a computer system for playback.

Power supply 110 provides power to video-capture device 100. A battery or an external power source, e.g., a conventional AC outlet, may provide the power. Optical components 112, which may include one or more lenses, capture the scene, and project an image of the scene onto digital video image sensor 114. Optical components 112 are configured to capture a sequence of images over a discrete period of time, e.g., 30 images or frames per second. Digital video image sensor 114 converts the captured images into digital video data and then transmits the digital video data to SOC 116 for further processing. Optical components may also include focusing and lens-orienting mechanisms, such as motors, to enable automatic focusing, and panning, tilting, and zooming of the field of view of video-capture device 100.

Digital viewfinder 118 is an electronic screen that displays previously captured composite video files and also displays an image of the scene being captured while the composite video file is being recorded. Digital viewfinder 118 is preferably a liquid crystal display (LCD). In one embodiment, digital viewfinder 118 includes a primary display screen that is active in hand-held capture mode and a secondary display screen that is active in automatic capture mode. The secondary screen may be oriented to be visible to the subjects of video that is currently being captured, thereby facilitating the use of video-capture device 100 in video chatting. The secondary screen may also be a different size than the primary screen. Alternatively, in one embodiment, the primary screen serves as the secondary screen by rotating to a position visible to the subjects when in automatic capture mode.

SOC 116 communicates with the various components within video-capture device 100 to control the operations of video-capture device 100. SOC 116 also processes inputs from interface buttons 120. For example, when video-capture device 100 is in hand-held capture mode, SOC 116 transmits the digital video data received from the digital video image sensor 114 to the primary screen of digital viewfinder 118 for display. Similarly, in automatic capture mode, SOC 116 transmits digital video data received from the digital video image sensor 114 to the secondary screen of digital viewfinder 118 for display. In one embodiment, SOC 116 combines the digital audio data received from the microphone 106 and the digital video data received from digital video image sensor 114 to create a composite video file. The composite video file may then be transmitted to internal memory 138 for storage. When video-capture device 100 is in playback mode, SOC 116 retrieves the composite video file from internal memory 138 and transmits the video portion of the composite video file to digital viewfinder 118 and the audio portion of the composite video file to speakers 104. In alternative embodiments, the digital audio data received from microphone 106 and the digital video data received from digital video image sensor 114 may be stored separately in internal memory 138.

SOC 116 includes a digital signal processor (DSP) 117 and a microprocessor (MP) core 115. DSP 117 is configured to efficiently perform digital signal processing tasks, including mathematically intensive computations, for video-capture device 100. In one embodiment, DSP 117 comprises a co-processor configured to execute instructions independently from microprocessor (MP) core 115. In an alternative embodiment, DSP 117 may comprise logic optimized to efficiently perform digital signal processing tasks and computations. MP core 115 is configured to execute a control application 142 disposed in memory 138 and DSP 117 is configured to execute a DSP application 144, also disposed in memory 138. Control application 142 includes instructions for determining when video-capture device 100 is hand-held by the user and for adjusting one or more settings of video-capture device 100, according to embodiments of the invention. Persons skilled in the art will recognize that the control application 142, driver 140, and DSP application 144 may be loaded into SOC 116 for execution. In one embodiment, the DSP application 144 may reside in embedded memory within SOC 116 rather than in a separate memory block, i.e., memory 138, as shown. Suitable types of embedded memory within SOC 116 include DRAM, SRAM, EPROM, flash, and the like.

Interface buttons 120 may include physical buttons, such as a power button and a record button (not shown). The power button is configured to turn video-capture device 100 on and off. The record button, when selected, begins and ends the recording of video and audio of a particular scene. Other interface buttons (not shown) may include, without limitation, a left button, a right button, an increase button, a decrease button, a play button, and a delete button, wherein each may be implemented as capacitive-touch buttons. The left button and the right button may be used to scroll through composite video files stored in internal memory 138. The increase button and the decrease button may provide various functions depending on the current operating mode of video-capture device 100. For example, when video-capture device 100 is in playback mode, the increase button may be used to increase the audio volume. In other modes, the increase button may be used to increase the magnification of an image being captured or viewed on digital viewfinder 118. Similarly, the decrease button may be used to decrease the audio volume in playback mode.

Device status sensors 130 include one or more sensors configured to determine when video-capture device 100 is disposed on a supporting surface and is not being operated manually by the user. Device status sensors 130 may include an inertial sensor, a tripod-mounted sensor, a tripod-deployed sensor, a pressure sensor disposed on the base and calibrated to the weight of the video-capture device, a resistive touch sensor, a capacitive touch sensor, a user-activated selector switch, and the like. An inertial sensor can detect when video-capture device 100 is motionless or when motion is substantially less than is typical when being held by a user. A tripod-mounted sensor may be disposed in a tripod mount of video-capture device 100 and may be configured to detect when video-capture device 100 is mounted on a tripod. A tripod-deployed sensor may be included in device status sensors 130 when video-capture device 100 is configured with an integrated tripod. The tripod-deployed sensor is configured to detect when the integrated tripod is deployed and therefore video-capture device 100 is assumed to be in automatic capture mode and is not hand-held. In one embodiment, a pressure sensor disposed on the base of video-capture device 100 detects when video-capture device 100 has been set onto a stationary surface and is no longer hand-held, i.e., when the pressure measured by the pressure sensor corresponds to the weight of video-capture device 100. In some embodiments, one or more touch sensors may be used to determine when video-capture device 100 is not being hand-held and is therefore disposed on a supporting surface. In one such embodiment, one or more resistive touch sensors are used; in another embodiment, one or more capacitive touch sensors are used. In addition to the above-mentioned sensors, video-capture device 100 may also include a user-activated mechanical selector switch to prevent accidental activation of automatic capture mode while the user is holding video-capture device 100.

Wireless communication system 140 is configured to transmit information to an external receiving device during video capture. In one embodiment, wireless communication system 140 includes a wireless local area network (WLAN) device to facilitate Internet access and the application of video-capture device 100 in video chatting. In another embodiment, wireless communication system 140 includes a personal area network (PAN) compatible device, such as a Bluetooth™-compatible device. In such an embodiment, video-capture device 100 may transmit user prompts, e.g., “low battery,” “low light,” etc., to an external receiving device so that a user may be informed about urgent issues regarding the status of video-capture device 100 when in automatic capture mode. Of course, wireless communication system 140 may also include a combination of WLAN and PAN devices.

Internal memory 138 stores the composite video files recorded by the user as well as firmware that is executed by SOC 116 to control the operations of video-capture device 100. Internal memory 138 comprises either volatile memory, such as dynamic random access memory (DRAM), or non-volatile memory, such as a hard disk or a flash memory module, or a combination of both volatile and non-volatile memory. Internal memory 138 also stores a software driver 140 implemented as a set of program instructions configured to coordinate operation between the interface buttons 120, device status sensors 130, wireless communication system 140, and the other components of video-capture device 100. For example, the program instructions that constitute the driver 140 may be executed by SOC 116 to cause different capacitive-touch buttons to be illuminated when video-capture device 100 is in different operating modes.

In operation, video-capture device 100 may be operated in either hand-held capture mode or automatic capture mode, and is configured to switch between the two modes with no active adjustment being made to settings by the user. Instead, video-capture device 100 automatically determines when it is being operated directly by the user and is in hand-held (manual) capture mode, and when it has been set down by the user (on a supporting surface, like a table top) and is in automatic capture mode. Video-capture device 100 then adjusts video capture and other settings accordingly depending on the current capture mode to enhance the quality of captured video. Thus, the user can begin video capture in one mode and easily switch to a different mode without stopping the video capture, paging through menu options, and adjusting settings to optimize video quality for the current capture mode.

In some embodiments, video-capture device 100 determines it is disposed on a supporting surface based on measurements by device status sensors 130. In some embodiments, video-capture device 100 determines it is no longer hand-held and is disposed on a supporting surface by processing captured video data with an optical flow algorithm to quantify visible shake of captured video. For example, when visible shake is measured to correspond to what is typical when video-capture device 100 is disposed on a supporting surface (and is no longer being held by the user), video-capture device 100 assumes it is in automatic capture mode and is not longer being operated by the user. In such an embodiment, optical flow may include determining a set of motion vectors between pairs of frames in the captured video, e.g., from frame 1 to frame 2, from frame 2 to frame 3, etc. Such motion vectors, called block motion vectors, may be calculated for blocks of an image, e.g., an 8×8 pixel block, and comparing the magnitude of consecutive block motion vectors can quantify shaking of video-capture device 100. Alternatively, a global motion vector may be calculated for the entire image, and the magnitude of the global motion vector may be determined through comparison to a predetermined threshold value.

According to embodiments of the invention, video-capture device 100 is configured to advantageously adjust settings depending on the current capture mode (hand-held capture mode or automatic capture mode), thereby enhancing captured video quality with few or no inputs by the user. A selection of such settings is now described. When video-capture device 100 has been placed in a substantially fixed position and is no longer hand-held, e.g., placed on a tabletop, fixed to a wall, hung by a support lanyard, mounted to a tripod, etc., one or more settings or features of video-capture device 100 may be adjusted. Suitable adjustments include activating wide field-of-view, activating automatic subject tracking, activating automatic focus, activating automatic framing, activating digital tilt adjustment, activating voice controls, amplifying a recording indicator light, activating remote indicator lights, adjusting microphone settings, activating a remote edge-of-frame warning indicator, activating an alternate display screen, activating an alternate recording lens, adjusting user prompt mechanisms, disabling image stabilization, and activating video conferencing.

Wide field-of-view optically zooms out to the widest possible field of view available for optical components 112. Activating wide field-of-view enhances captured video quality in automatic capture mode by eliminating the need to precisely aim video-capture device 100 when positioning the device for automatic capture mode. In addition, wide field-of-view may be used advantageously in conjunction with subject tracker and digital zooming (described below) to further enhance the quality of video captured in automatic capture mode.

Automatic subject tracking utilizes algorithms in DSP application 144 and control application 142 to digitally or optically center the video captured by video-capture device 100 on a subject, including a face, a person, or an object. Such algorithms are well known in the art. Activating automatic subject tracking in automatic capture mode ensures that subjects remain in the captured video even though the user is not directly operating video-capture device 100. As noted above, automatic subject tracking may be used in conjunction with wide field-of-view.

Automatic framing utilizes optical and/or digital zooming, panning, and tilting to effectively center a subject or subjects in the captured video. For example, when tracking a person, skin tone may be used by algorithms in DSP application 144 to distinguish the subject from other background objects. Such algorithms are well known in the art. Automatic focus may also be utilized as part of automatic framing algorithms. In some embodiments, automatic framing may also enhance the quality of captured video when in automatic capture mode by detecting occluding objects, such as objects on the table on which video-capture device 100 has been place or other objects in the foreground. Once detected, the occluding objects can be removed from the captured video by modifying or limiting the field of view via digital or mechanical zooming or panning. Alternatively, the effect of occluding objects can be minimized by keeping them out of focus.

To further enhance video quality when automatic framing is activated, exposure settings for the captured video can be adjusted to disregard occluding objects when determining the correct exposure for the captured video. In some embodiments, tilt adjustment may also be applied as part of the automatic framing feature. Tilt adjustment can compensate for the tilted view that results when video-capture device 100 is resting on a supporting surface that is not level. Tilt adjustment may be accomplished by video-capture device 100 using one or more tilt sensors, such as accelerometers, to determine orientation of video-capture device 100. Tilt correction may take place immediately by mechanically tilting optical components 112 as needed to negate the visual effects of the non-level supporting surface. Alternatively, tilt adjustment of video capture may be performed digitally, either in real time or, because of processing limitations, via post-processing of captured video. For digital tilt adjustment post-processing, a degree of tilt may be registered using the tilt sensor and stored as a meta-tag in the video file.

In addition to subject tracking, elimination of occluding objects, and tilt adjustment, creative framing and/or automatic cuts can be used when automatic framing is activated. Even though video captured by video-capture device 100 may be correctly framed to include all subjects when in automatic capture mode, this may not be the effect desired by the user. For more interesting video, video-capture device 100 may automatically alter framing when automatic framing is activated. For example, digital or optical zoom may be used to zoom in on a particular subject when talking. In some embodiments, automatic framing is also configured to cut back to a wide angle when the subject changes. In one embodiment, digital zoom is used for zoom-in on a particular subject and for the quick cut back to wide angle upon subject change. In such an embodiment, only a single lens is needed for such an effect. Other creative framing techniques may also be employed when automatic framing is activated. For example, exaggerated tilt may be activated as part of automatic framing for dramatic effect. Such modifications to conventional framing techniques may be initiated automatically, by voice commands received from the user via microphone 106, or as part of a pre-programmed sequence. Algorithms for automating such creative framing techniques are well-known in the art, for example in current video conferencing technology.

As described in greater detail herein, besides automatic framing, a number of other features may be activated in automatic capture mode that are particularly advantageous for video chatting/conferencing and other situations in which the user is in the captured video. Activating voice controls allows the user to use voice or other audible commands instead of interface buttons 120 to control video-capture device 100 remotely, thereby enabling the user to adjust the operation of video-capture device 100 while remaining in the captured video. Such audible controls, e.g., verbal commands, clapping, snapping, etc., may be received via microphone 106. Amplifying a recording indicator light helps the user determine when video-capture device 100 is actually recording even when positioned at a distance from the device. Activating remote indicator lights indicates to the user and other subjects of the captured video who and/or what video-capture device 100 is currently capturing on video. In some embodiments, activating remote indicator lights includes activating one or more light sources, such as a laser pointer, light-emitting diode (LED), or other light, to indicate the limits of a video capture frame. In some embodiments, activating remote indicator lights includes activating a light source to indicate a focus point of the video-capture device. In either case, the user and other subjects can be effectively made aware of the limits of the current frame and/or focus point of video-capture device 100.

Adjusting microphone settings can also be advantageous for video chatting, video conferencing, and other scenarios in which automatic capture mode is used. In some embodiments, one or more directional microphones are activated when video-capture device 100 is determined to be in automatic capture mode. The directional microphones may be microphones that make up microphone 106. Alternatively, one or more of the directional microphones so activated may be remote microphones and may communicate with video-capture device 100 via wireless communication system 140 or data connector 102. In some embodiments, the mechanical operations of video-capture device 100, e.g., panning, zooming, etc., are coordinated with one or more microphones of the video-capture device. Specifically, noise-generating motorized operations are halted when one or more microphones proximate video-capture device 100 are actively receiving audio. In this way, the operation of video-capture device 100 is prevented from degrading audio quality of captured video. Similarly, in some embodiments, microphones proximate video-capture device 100 may be inactivated when motorized zooming, panning, and tilting are taking place.

In some embodiments, as described in greater detail herein, a remote edge-of-frame warning indicator is activated when video-capture device 100 is in automatic capture mode. In such an embodiment, a warning indicator, e.g., a blinking light, blinking directional arrow, or tone, is emitted by video-capture device 100 when a subject nears the limit of the field of view of video-capture device 100, thereby preventing a subject from exceeding the ability of video-capture device 100 to track the subject using optical and/or digital panning and zooming.

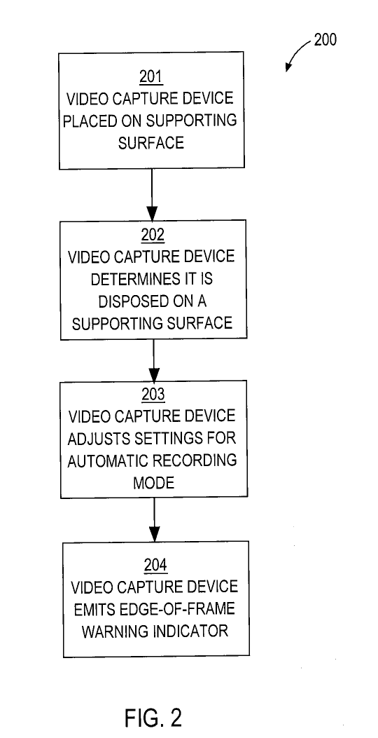

FIG. 2 is a flow chart of a method 200 for capturing video while using remote edge-of-frame warning indicators, according to one example embodiment of the invention. Although the method steps are described in conjunction with a video-capture device substantially similar to video-capture device 100 of FIG. 1, persons skilled in the art will understand that any system or device configured to perform the method steps, in any order, falls within the scope of the invention.

Method 200 begins in step 201, when video-capture device 100 is placed on a supporting surface and positioned to capture video in a desired location. In step 202, video-capture device 100 determines that it is disposed on a supporting surface and is no longer being operated manually by a user. In some embodiments, a signal may be received from a sensor incorporated into the device 100 indicating that the device 100 is no longer being held by the user (e.g., in the case where the user places the device 100 on a supporting surface, like a table top). In other embodiments, such a determination is made by processing video data captured by video-capture device 100 to quantify visible shake contained in captured video data and establish whether visible shake is at a level that corresponds to when video-capture device 100 is disposed on a supporting surface. In other embodiments, any technically feasible way of determining when video-capture device 100 is disposed on a supporting surface may be implemented. In step 203, video-capture device 100 adjusts one or more settings to compensate for the fact that video-capture device 100 is no longer being operated manually by the user and is disposed on a supporting surface, including activation of remote edge-of-frame warning indicators. In various embodiments, an optical flow algorithm may be implemented in processing the captured video data. In step 204, a warning indicator, e.g., a blinking light, blinking directional arrow, or tone, is emitted by video-capture device 100 when a subject nears the limit of the field of view of video-capture device 100.

In yet other embodiments, an alternate display screen and/or recording lens may be activated when video-capture device 100 is determined to be in automatic capture mode. For example, a larger display screen facing in the same direction as the recording lens may be activated to facilitate video conferencing. Similarly, an alternate recording lens that has a wider field of view or is otherwise optimized for video conferencing may be activated when video-capture device 100 is determined to be in automatic capture mode.

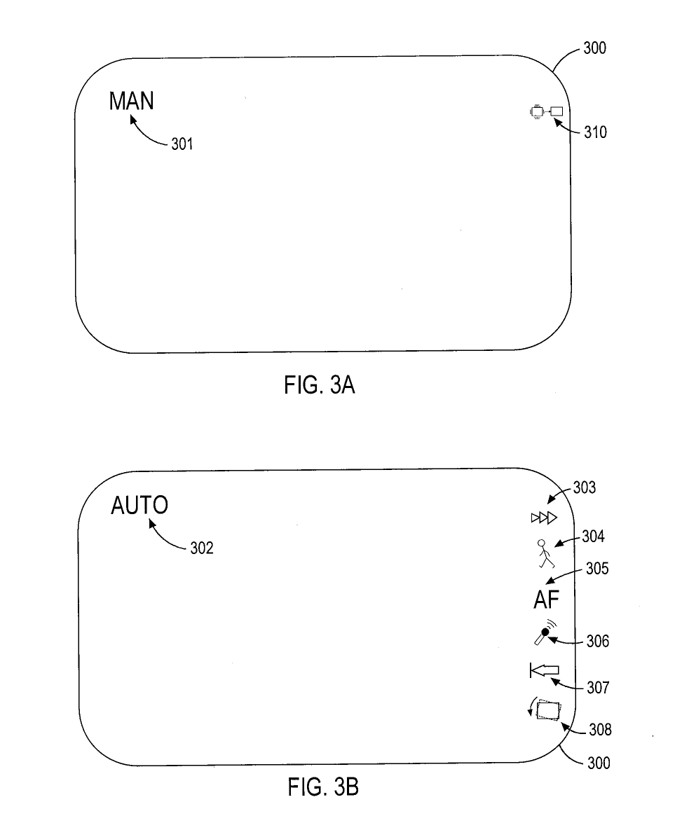

In other embodiments, icons may be displayed by viewfinder 118 and/or an alternate display screen to indicate what features have been activated when video-capture device 100 is in automatic capture mode. For example, FIG. 3A is a schematic diagram of a user interface screen 300 of video-capture device 100 when video-capture device 100 is in manual capture mode, according to one example embodiment of the invention. User interface screen 300 may be viewfinder 118 and/or an alternate display screen that is activated when video-capture device 100 is in manual capture mode. Icon 301 is displayed and indicates that video-capture device 100 is in manual capture mode, i.e., hand-held by the user. Icon 310 is also displayed on user interface screen 300 and indicates that image stabilization is activated. In another example, FIG. 3B is a schematic diagram of user interface screen 300 when video-capture device 100 is in automatic capture mode, i.e., disposed on a supporting surface, according to one example embodiment of the invention. Icon 302 is displayed and indicates that video-capture device 100 is in automatic capture mode, i.e., video-capture device 100 has determined that it has been placed on a supporting surface. Icons 303-308 are also displayed and indicate other features that are activated in automatic capture mode. Specifically, icon 303 indicates that an auto zoom function is activated, icon 304 indicates that subject tracking is activated, icon 305 indicates that auto focus is activated, icon 306 indicates that one or more directional microphones are activated, icon 307 is an edge-of-frame warning indicator that is displayed when a subject moves too close to the edge of the viewable frame, and icon 308 is a digital tilt adjust icon and is displayed when the visual effects of a non-level supporting surface is being negated digitally. The features indicated by icons 303-308 are intended as examples. Other video capture settings may of course also be indicated as activated on user interface screen 300, as applicable.

The mechanism by which prompts are delivered to the user may be modified when video-capture device 100 is determined to be in automatic capture mode. Since video-capture device 100 is disposed on a supporting surface and digital view finder 118 may not be visible to the user, displaying prompts such as “Battery Low,” “Connect to WiFi Network?,” “Subject Too Dark,” etc., need not be displayed. In one embodiment, user prompts directed to the display screen may be disabled. In an alternative embodiment, user prompts may be converted to audio prompts using speaker 104. In another embodiment, user prompts may be transmitted to a receiving device, e.g., a remote control, the user's cell phone, a Bluetooth™ headset, etc., via wireless communication system 140.

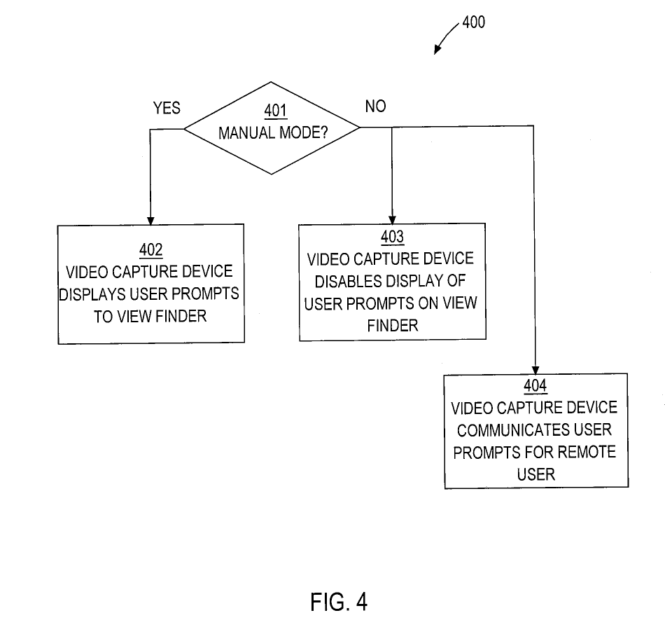

FIG. 4 is a flow chart of a method 400 for displaying user prompts in manual capture mode and in automatic capture mode, according to one example embodiment of the invention. Although the method steps are described in conjunction with a video-capture device substantially similar to video-capture device 100 of FIG. 1, persons skilled in the art will understand that any system or device configured to perform the method steps, in any order, falls within the scope of the invention.

Method 400 begins in step 401, when video-capture device 100 checks whether video-capture device 100 is in automatic capture mode or manual capture mode. Different embodiments by which video-capture device 100 makes such a determination are described above in step 202 of method 200. If in manual capture mode, video-capture device 100 proceeds to step 402, and displays user prompts to digital viewfinder 118. If in automatic capture mode, video-capture device 100 proceeds to step 403, and disables the display of user prompts to digital viewfinder 118. Optionally, video-capture device 100 may continue to step 404, and communicate user prompts for a remote user, e.g., by playing audio prompts using speaker 104 or transmitting user prompts to a receiving device.

Image stabilization also may be disabled when video-capture device 100 is in automatic capture mode. Because a fixed support is used, the additional processing required for image stabilization algorithms is unnecessary.

Video conferencing may be activated when video-capture device 100 is in automatic capture mode. Wireless communication system 140 connects to an available Internet connections and captured video is transmitted accordingly. In addition, a display screen, e.g., digital viewfinder 118, a secondary display screen oriented toward the user/subject, or a remote display screen, is activated to facilitate video chatting or video conferencing.

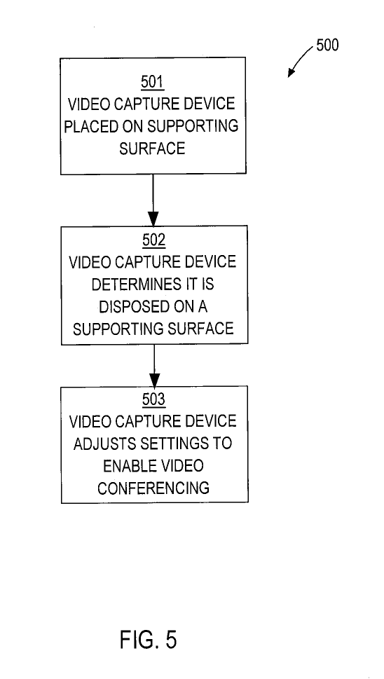

FIG. 5 is a flow chart of a method 500 for automatically activating video conferencing features of a video-capture device, according to one example embodiment of the invention. Although the method steps are described in conjunction with a video-capture device substantially similar to video-capture device 100 of FIG. 1, persons skilled in the art will understand that any system or device configured to perform the method steps, in any order, falls within the scope of the invention.

Method 500 begins in step 501, when video-capture device 100 is placed on a supporting surface and positioned to capture video in a desired location, such as for a video chat session. In step 502, video-capture device 100 determines that it is disposed on a supporting surface and is no longer being operated manually by a user. Different embodiments by which video-capture device 100 makes such a determination are described above in step 202 of method 200. In step 503, video-capture device 100 adjusts one or more video capture settings to enable video conferencing, including but not limited to automatic framing and subject tracking, activation of voice controls, activation of remote edge-of-frame warning indicators, adjustment of microphone settings, and activation of a secondary display screen.

In addition to the foregoing, in various embodiments, other conditions may initiate an adjustment in video capture settings besides the determination that video-capture device 100 is in automatic capture mode. For example, in one embodiment, when video chatting or conferencing is activated, one or more of the above-described features may be activated automatically. Suitable features include automatic framing, automatic subject tracking, wide field-of-view, etc.

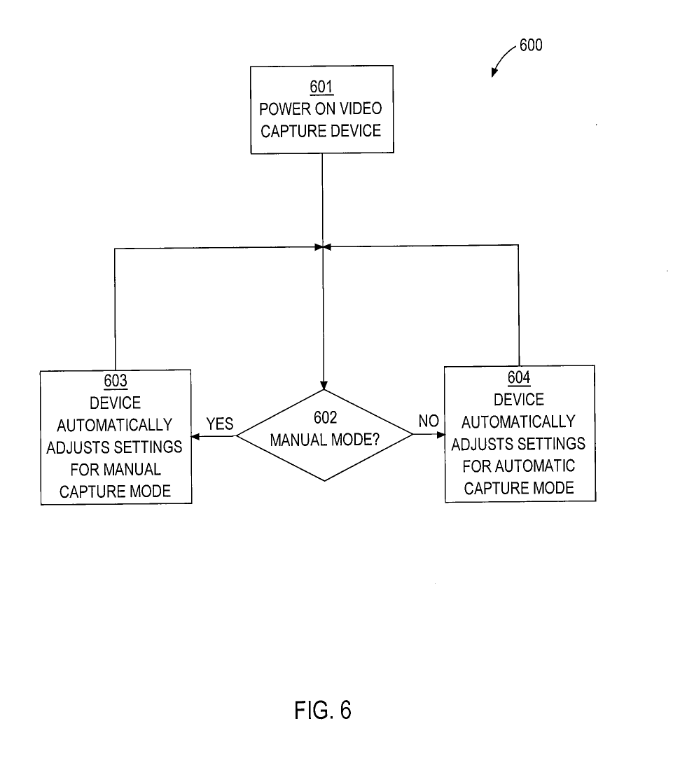

FIG. 6 is a flow chart of a method 600 for changing a video-capture device from a manual capture mode to an automatic capture mode, according to one example embodiment of the invention. Although the method steps are described in conjunction with a video-capture device substantially similar to video-capture device 100 of FIG. 1, persons skilled in the art will understand that any system or device configured to perform the method steps, in any order, falls within the scope of the invention. It is noted that method 600 may be performed when video-capture device 100 is recording, transmitting, and/or monitoring video and audio detected by video-capture device 100.

Method 600 begins in step 601, in which video-capture device 100 is powered on. In step 602, video-capture device 100 determines whether it is in manual capture mode, i.e., hand-held by the user, or in automatic capture mode, i.e., resting on a supporting surface. If video-capture device 100 is in manual capture mode, the method proceeds to step 603, in which video-capture device 100 automatically adjusts one or more video capture settings for optimal performance in manual capture mode. If video-capture device 100 is in automatic capture mode, the method proceeds to step 604, in which video-capture device 100 automatically adjusts one or more video capture settings for optimal performance in automatic capture mode, e.g., subject tracking, auto focus, directional microphones, etc., are activated. The method then proceeds to step 602 and re-checks the auto/manual status of video-capture device 100.

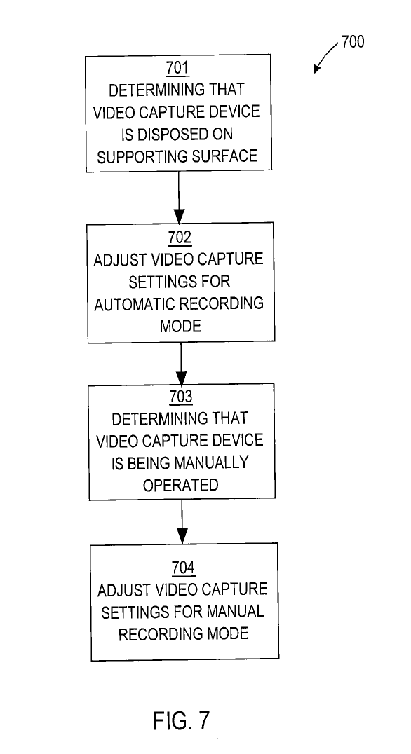

FIG. 7 is a flow chart of a method 700 for capturing video, according to one example embodiment of the invention. Although the method steps are described in conjunction with a video-capture device substantially similar to video-capture device 100 of FIG. 1, persons skilled in the art will understand that any system or device configured to perform the method steps, in any order, falls within the scope of the invention. It is noted that method 700 may be performed when video-capture device 100 is recording, transmitting, and/or monitoring video and audio detected by video-capture device 100.

As shown, method 700 begins in step 701, where video-capture device 100 determines that it is disposed on a supporting surface and is no longer being operated manually by a user. Different embodiments by which video-capture device 100 makes such a determination are described above in step 202 of method 200.

In step 702, video-capture device 100 automatically adjusts (i.e., modify, activate, deactivate, etc.) at least one video capture setting upon determining that it is disposed on a supporting surface. Video capture settings that may be so adjusted include, without limitation, wide field-of-view, automatic subject tracking, automatic focus, automatic framing, digital tilt adjustment, voice controls, recording indicator light brightness, remote indicator lights, microphone settings, remote edge-of-frame warning indicator, alternate display screen and/or lens, user prompt mechanisms, image stabilization, and video conferencing.

In step 703, video-capture device 100 determines that it is again being operated manually by the user (i.e., the user has picked up video-capture device 100 or otherwise removed the device from a supporting surface and is ready to manually operate the device 100). Such a determination may be made using any one of the techniques described above for step 701.

In step 704, video-capture device 100 automatically reverses the adjustments to video capture settings made in step 702.

In sum, example embodiments of the invention provide a system and method for video-capture that improves the quality of video content for a hand-held video-capture device that is disposed on a supporting surface and is not being manually operated by the user. Framing of subjects and sound quality are improved, and the presence of occluding objects in the field of view can be eliminated or minimized. In addition, the convenience of video chatting and video conferencing may be greatly increased, since a video capture device configured according to embodiments of the invention automatically optimizes video capture settings for video chatting and video conferencing when the device is placed by the user on a supporting surface, such as a table top.

While the foregoing is directed to various example embodiments of the present invention, other and further embodiments of the invention may be devised without departing from the basic scope thereof, and the scope thereof is determined by the claims that follow.

I claim:

1. A method for capturing video in a video-capture device, the method comprising:
determining that the video-capture device is disposed on a supporting surface; and
in response, automatically adjusting at least one setting of the video-capture device from a first setting to a second setting.

2. The method of claim 1, wherein determining that the video-capture device is disposed on a supporting surface comprises receiving a signal from a sensor indicating that the video-capture device is disposed on the supporting surface.

3. The method of claim 2, wherein the sensor is selected from the group consisting of an inertial sensor, a tripod-mounted sensor, a tripod-deployed sensor, a pressure sensor, a resistive touch sensor, a capacitive touch sensor, and a user-activated selector switch.

4. The method of claim 1, wherein determining that the video-capture device is disposed on a supporting surface comprises processing video data captured by the video-capture device to establish that visible shake contained in the video data corresponds to a level of visible shake known to occur when the video-capture device is disposed on a supporting surface.

5. The method of claim 1, wherein adjusting at least one setting of the video-capture device from a first setting to a second setting comprises activating wide field-of-view, activating automatic subject tracking, activating automatic focus, or activating automatic framing.

6. The method of claim 5, wherein activating automatic framing comprises digitally detecting one or more occluding objects or activating a light source to indicate a limit of a captured video frame.

7. The method of claim 1, wherein adjusting at least one setting of the video-capture device from a first setting to a second setting comprises activating digital tilt adjustment, activating voice controls, amplifying a recording indicator light, activating remote indicator lights, adjusting microphone settings, activating a remote edge-of-frame warning indicator, activating an alternate display screen, activating an alternate recording lens, adjusting one or more user prompt mechanisms, disabling image stabilization, or activating video conferencing.

8. The method of claim 7, wherein activating remote indicator lights comprises activating a light source to indicate a focus point of the video-capture device.

9. The method of claim 7, wherein adjusting microphone settings comprises activating at least one directional microphone or coordinating one or more mechanical operations of the video-capture device with a microphone included in the video-capture device.

10. The method of claim 7, wherein adjusting user one or more prompt mechanisms comprises at least one of disabling screen user prompts, switching to audio user prompts, and transmitting user prompts to a receiving device.

11. The method of claim 1, further comprising:
determining that the video-capture device is no longer disposed on the supporting surface; and
in response, automatically adjusting the at least one setting of the video-capture device from the second setting to the first setting.

12. A computer-readable storage medium that includes instructions that, when executed by a processing unit of a video-capture device, cause the processing unit to capture video by performing the steps of:
determining that the video-capture device is disposed on a supporting surface; and
in response, automatically adjusting at least one setting of the video-capture device from a first setting to a second setting.

13. The computer-readable storage medium of claim 12, wherein determining that the video-capture device is disposed on a supporting surface comprises processing video data captured by the video-capture device to establish that visible shake contained in the video data corresponds to a level of visible shake known to occur when the video-capture device is disposed on a supporting surface.

14. The computer-readable storage medium of claim 12, wherein adjusting at least one setting of the video-capture device from a first setting to a second setting comprises activating wide field-of-view, activating automatic subject tracking, activating automatic focus, or activating automatic framing.

15. The computer-readable storage medium of claim 12, wherein adjusting at least one setting of the video-capture device from a first setting to a second setting comprises activating digital tilt adjustment, activating voice controls, amplifying a recording indicator light, activating remote indicator lights, adjusting microphone settings, activating a remote edge-of-frame warning indicator, activating an alternate display screen, activating an alternate recording lens, adjusting one or more user prompt mechanisms, disabling image stabilization, or activating video conferencing.

16. A video-capture device, comprising:
a processing unit configured to automatically adjust at least one device setting from a first setting to a second setting in response to determining that the digital video capture device is disposed on a supporting surface.

17. The video-capture device of claim 16, further comprising a memory that includes instructions that, when executed by the processing unit, cause the processing unit to automatically adjust the at least one setting.

18. The video-capture device of claim 17, wherein the memory further includes instructions that, when executed by the processing unit, cause the processing unit to determine when the video-capture device is disposed on the supporting surface.

19. The video-capture device of claim 16, further comprising a sensor configured to detect that the video-capture device is disposed on the supporting surface.

20. The video-capture device of claim 19, wherein the sensor is selected from the group consisting of an inertial sensor, a tripod-mounted sensor, a tripod-deployed sensor, a pressure sensor, a resistive touch sensor, a capacitive touch sensor, and a user-activated selector switch.
